(19) United States
(12) Patent Application Publication
(10) Pub. No.: US 2018/0289189 A1
(43) Pub. Date: Oct. 11, 2018

(54) CLOTHES HANGER RECHARGER DEVICE

(71) Applicant: Teveri LLC, Salt Lake City, UT (US)

(72) Inventors: Gianluca Lazzi, Salt Lake City, UT (US); Dulce Maria Altabella Lazzi, Salt Lake City, UT (US); Kyle Loizos, Salt Lake City, UT (US)

(73) Assignee: Teveri LLC, Salt Lake City, UT (US)

(21) Appl. No.: 15/947,657

(22) Filed: Apr. 6, 2018

Related U.S. Application Data
(60) Provisional application No. 62/482,660, filed on Apr. 6, 2017.

(51) Int. Cl. A47G 25/14; A41D 1/00; H02J 50/12

(52) U.S. Cl. CPC A47G 25/14; H02J 50/12; A41D 1/002

(57) ABSTRACT

A charging hanger device is provided to include one or more power transmitter elements to transfer power from a first power source to a second power source implemented on a textile article capable of being hung on the hanger, where the power transmitter element is to wirelessly transmit the power to a power receiver element implemented on the textile article.

### CROSS-REFERENCE TO RELATED APPLICATIONS

This application claims benefit to U.S. Provisional Patent Application Ser. No. 62/482,660, filed Apr. 6, 2017, which is incorporated by reference herein in its entirety.

### BACKGROUND

The present disclosure relates in general to the field of computer systems, and more specifically, to a recharger for wearable devices and other smart textile-based devices.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive. The trend toward miniaturization of computing hardware, peripherals, as well as of sensors, detectors, and image and audio processors, among other technologies, has helped open up a field sometimes referred to as “wearable computing.” A variety of wearable computing devices are being developed allowing electronic components to be carried on human and animal users.

### BRIEF DESCRIPTION OF THE DRAWINGS

FIG. 1 illustrates a simplified schematic diagram of an example clothes hanger device including a charging element in accordance with at least some embodiments.

FIGS. 2A-2B illustrate simplified diagrams showing example wireless charging using an example charging hanger device in accordance with at least some embodiments.

FIG. 3 illustrates a simplified schematic diagram of an example charging hanger device including multiple charging elements in accordance with at least some embodiments.

FIG. 4 illustrates a simplified schematic diagram of another example charging hanger device including multiple charging elements in accordance with at least some embodiments.

FIGS. 5A-5B illustrates simplified block diagrams showing example wireless charging using an example charging hanger device in accordance with at least some embodiments.

FIG. 6 illustrates a simplified schematic diagram of an example charging hanger device in accordance with at least some embodiments.

FIG. 7 illustrates a simplified schematic diagram of another example charging hanger device in accordance with at least some embodiments.

FIG. 8 illustrates a simplified schematic diagram of an example charging hanger device with removable charging elements in accordance with at least some embodiments.

Like reference numbers and designations in the various drawings indicate like elements.

### DETAILED DESCRIPTION

In one example, a clothes hanger device is provided that includes modules, which may wirelessly transfer power and/or data to/from electronics integrated in a garment. In some instances, a smart garment may be powered by rechargeable batteries and the clothes hanger may provide inductive, capacitive, or radiative charging of batteries included in garments equipped with electronics to enhance the garment. Indeed, “wireless” power or energy transfer, as used herein, may refer to inductive, capacitive, or radiative energy transfer. Further, the clothes hanger may include an antenna and communication module to enable the uni- or bi-directional transfer or receipt of data to/from the garment, for example to receive system data, data log, or reprogram the firmware in the garment. For instance, the garment (e.g., through sensors integrated on the garment) may collect and record data over a period of time (e.g., hours, days, months, etc.) and “dump” it on the hanger unit when recharging (for example, on a memory stick integrated with or connectable to the hanger). Further, data may be uploaded to or otherwise provided on the hanger, which the hanger can share with the garment (e.g., for use in upgrading or reprogramming logic of the garment (e.g., firmware update)) and data from the garment can be used for log transfer, or to transmit malfunction signals, among other possible examples

In one example, a charging clothes hanger (or simply “charging hanger” may include a power source, such as a battery or a connection to an external source (i.e. via a cable), from which power may be transferred to a charger of battery unit(s) in a garment. The charging hanger may additional include (e.g., contain) one or more electromagnetic radiators/receivers, resonators, or other electromagnetic component capable of transferring power and/or transmitting and/or receiving data to electronics in garments via coupling with one or more radiators/receivers or resonators provided on the garment (e.g., integrated into the fabric of the garment, or otherwise attached to the garment). It should be appreciated that, while the disclosure discusses “resonators”, this term, as used herein, refers both to elements which are resonant as well as those that are sub-resonant. Further, in implementations utilizing radiative or capacitive charging, other circuitry and elements may be provided to implement the corresponding power transmitter and receiver (e.g., other than resonators). For instance, for an implementation utilizing capacitive charging, an electrode charge plate may be provided within each of the charging hanger and the textile device to be charged using the hanger. Similarly, in implementations utilizing radiative charging, or power beaming, the charging hanger may be provided with an antenna, laser aperture, or other element to transfer energy from its power source to the receiver on the smart garment, or other textile device, among other examples.

In accordance with the foregoing, an example charging hanger may serve as a wireless charger for power sources powering electronics integrated into clothing, such as lighting, speakers, sensors (i.e. electrodes or optics for a heart rate monitoring device, stretchable fibers serving as piezoelectric sensing elements for applications such as a respiration sensor, etc.), or any other medical or consumer electronic device that is built into a piece of clothing. This charging/recharging of the battery-equipped garment may thus take place while the garment is being hung (e.g. in a closet) using the charging hanger. In some cases, the unit embedded in the hanger can be removed from the hanger, thus enabling a stand-alone charging system which may be suitable, for example, for travel. In some implementations, the charging hanger device may provide wireless charging in accordance with one or more defined charging standards. Such standards may include, as examples, the Wireless Power Consortium's Qi standard, standard provided or endorsed by the AirFuel Alliance, among other examples.

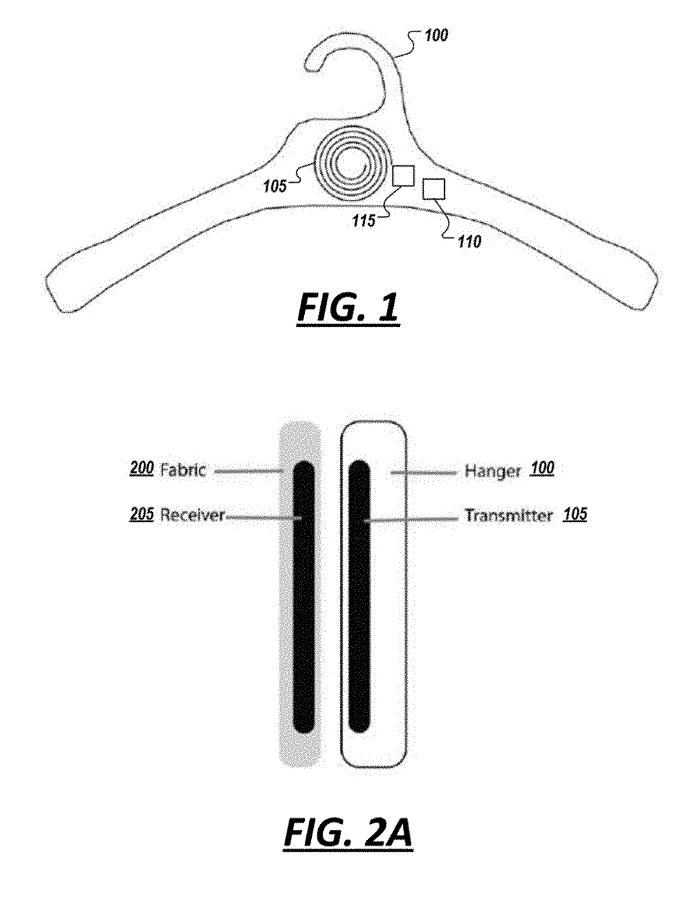

Turning to the particular example of FIG. 1, an example charging hanger device 100 is shown including a representation of an example power transfer (or transmitter) element 105, such as a transmitting coil provided within the body of or on the face of the clothes hanger device 100. The power transmitter element 105 may be attached to a power supply 115, such as a (rechargeable) battery container within the charging hanger or an external power source to which the charging hanger connects to (e.g., while hanging on a rod, hook, etc.) and draws power for use by the transmitting coil. Circuitry may be provided in or in connection with the power transmitter element 105 to convert or otherwise use electric energy from the power supply 115 for transferring power to a power receiver element of another device.

Additional circuitry may be provided within the body of or otherwise contained within the clothes-hanger-shaped device 100. For instance, in addition to the power transfer element 105, circuitry 110 may be provided to detect when other devices have been brought into contact with or sufficient proximity of the power transfer element 105 to be charged by the power transfer element 105. Additionally, charge monitoring circuitry 110, such as a microcontroller or battery charger integrated chip, may be provided in the hanger device 100 to detect the charging status of a battery or other energy store of the other device charged by the hanger device 100. For instance, the charge monitoring circuitry may identify when charging of the other device is being performed by the power transfer element, as well as, in some instances, detecting when the subject other device is fully charged. In some implementations, the device being charged by the hanger device may include a battery charge detection circuitry and may send a wireless signal to the hanger device, which may be received by an antenna of the hanger device to determine that charging has been completed, thereby causing the hanger device to cease charging (e.g., to conserve energy), among other example features.

In some implementations, a visual or audio indicator may be provided in or on the hanger device 100 to indicate the detected charging status to a user. In one implementation, one or more light emitting diodes (LEDs) may be provided in the hanger device to present various colors or patterns of light to indicate charging status of an electronic article of clothing hanging on the hanger device. For instance, the hanger device may be composed of hollow plastic, which is at least partially transparent to allow light emitted from LEDs within the hollow hanger body to illuminate the hanger body so as to indicate to a user that an electronic garment hanging on the hanger device is charging or charged, among other examples. Indeed, in some implementations, the hanger device 100 may be composed of a housing for the power transfer element 105, charge monitoring circuitry 110, a power supply (and associated circuitry) (e.g., 115), indicator devices (e.g., LEDs, speakers or chimes for audio indicators, etc.), among other components of the hanger device. The housing of the hanger device 105 may be formed from plastic or another material. Remaining portions of the hanger device 105 may be composed of the same or different material as used in the housing of the hanger device 105, among other example implementations.

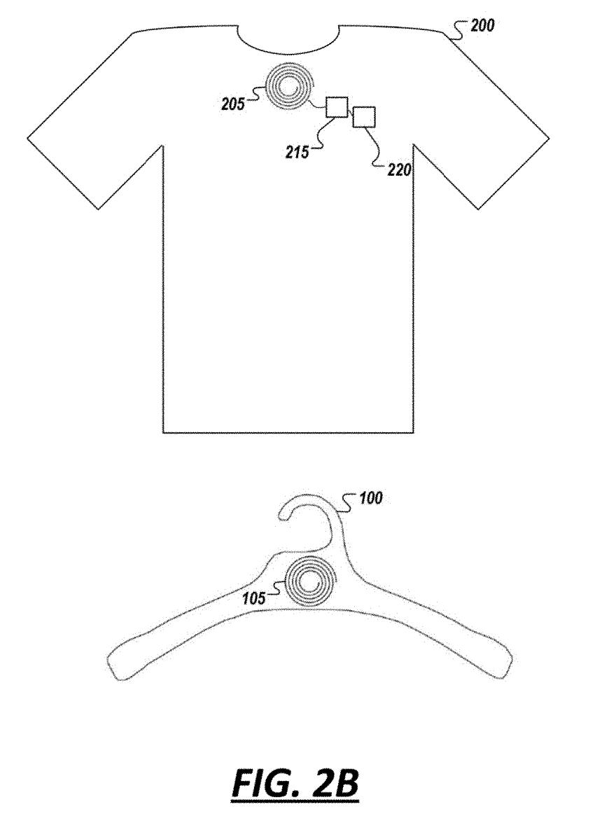

Turning to the representation shown in FIG. 2A, a representation is shown of a portion of a garment 205 (or other textile) to which a receiving coil (or other electromagnetic power receiver element) 210 is attached. In some implementations, an example coil-based power receiver element 210 may be integrated (e.g., sewn or woven into the textile itself, embedded between two fabric layers, etc.) into the garment 205 itself. In other instances, the power receiver element 210 may be otherwise attached (e.g., adhered, fastened, etc.) to the surface of the garment 205. When the corresponding garment is hung on an example charging hanger, the receiving coil 210 of the garment may be aligned with a transmitting coil (or other power transfer element) 105 provided on the charging hanger 100, allowing power from the power supply of the hanger device 100 to be transmitted to the receiving coil 205 for use in charging a battery or other power store integrated with the garment (or other textile article) 200.

Turning to FIG. 2B, garments and other smart textile-based products requiring power to facilitate various enhanced, electronic functionality in the product, may be adapted for recharging using an example charging hanger device (e.g., 100). For instance, in the example of FIG. 2B, the power receiver element 205 within an example smart textile device, such as the smart garment 200 shown in the illustration of FIG. 2B, may be positioned within the garment so that it corresponds with (and is more likely to align with) a known location of a power transmitter element 105 of a charging hanger device 100 when the garment 200 is hung on the hanger device 100. The power receiver element 205 may connect to a power source 215 of the smart garment, which powers circuits and electronic components (e.g., 220) provided on or within the smart garment to provide various enhanced functionality. In some cases, wires connecting the power receiver element 205, battery 215, and/or electronic components (e.g., 220) may be embodied as flexible, liquid metal wires. Indeed, liquid metal wires may be utilized to implement the electronic components themselves, such as touch sensors or elements, including those elements described, for example, in Patent Cooperation Treaty (PCT) Patent Application PCT/US17/56198, filed Oct. 11, 2017, which is incorporated herein by reference.

While the example of FIG. 1 shows an example charging hanger with a single transmitting coil (e.g., 105), garments may take a variety of shapes and forms. Further, the principles discussed herein relating to features of an example charging hanger may also be applied to other clothes and textile hanging apparatus, such as wall or door hook hangers, tie and scarf hangers, bedspread/tablecloth hangers, open slack hangers, skirt hangers, cascading hangers, coat hanger bars, among other examples. In some implementations, a single transmitting coil may be insufficient to serve as a charging mechanism for certain types of smart garments (e.g., garments cut with a low neckline, such as an exercise shirt, sports bra, bathing suit top, etc.), as the garment may lack fabric to support a receiving coil at the location provided in the charging hanger. Accordingly, a charging hanger with a single transmitting coil located in a single standardized location (e.g., as in the example of FIG. 1) may not be capable of charging all garments developed (and yet to be developed) with cuts, aesthetic features (e.g., which may impede the placement of a power receiver element), closures, and designs which may not be compatible with a single transmitter charging hanger design.

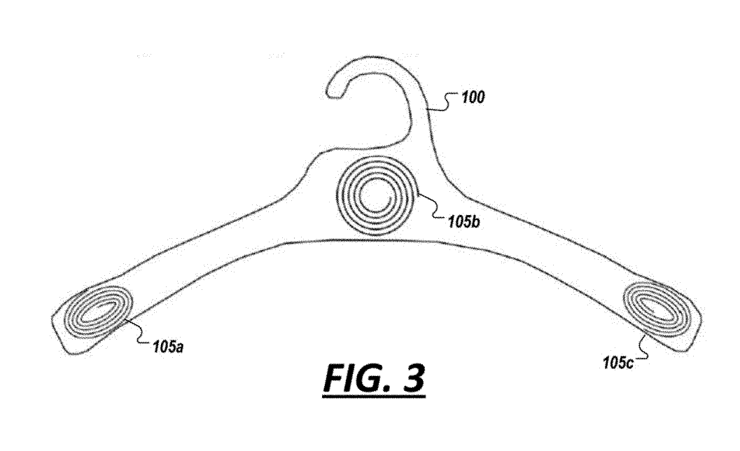

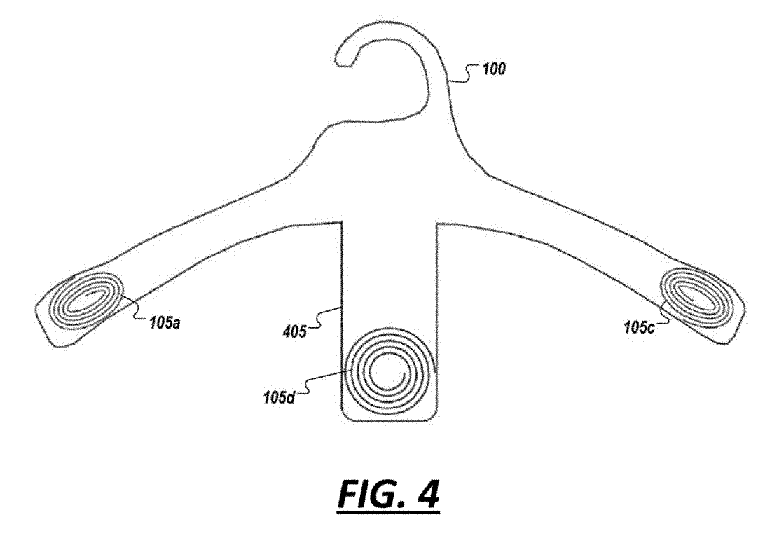

Accordingly, in some implementations, such as illustrated in FIG. 3, a charging hanger may be provided with multiple power transfer elements (e.g., 105a-c), such as transmitting coils, antennas (e.g., to work at higher frequencies (e.g., dipoles or patch), such as to support data transmission), or other power transmitter elements located in different positions using the structure of the charging hanger. Such a design may allow the charging hanger to be more flexibly compatible with a variety of different smart garments that place receiving coil(s) in potential different locations of a garment (e.g., chest or back below the neckline (e.g., to align with transmitting coil 105b), at a shoulder or sleeve of the garment (corresponding to locations of transmitting coils (e.g., 105a-c)), among other examples (which may include additional power transmitter elements in still other alternative locations. For instance, FIG. 4 shows another example implementation of a charging hanger, which includes an appendage 405 extending from the main body of a traditional hanger design to provide another power transmitter element in a location other than the potential transmitter locations available in the physical structure of a traditional hanger design (e.g., different from or outside the typical outline of a clothes hanger (e.g., outside of the portion(s) of the hanger used to structurally support garments to be hung on the hanger, such as with inductive coil 105d)). In still other implementations, additional or alternative appendages (beyond or different from the appendage design 405 shown in the particular example of FIG. 4), may be provided to extend the universe of locations of potential power receivers (of smart textile products), which may be charged wirelessly using an example charging hanger device.

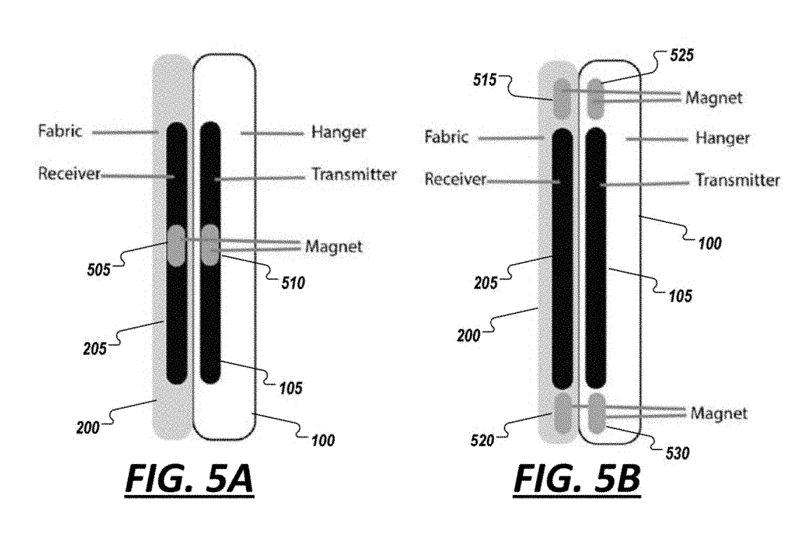

In some implementations, to ensure optimal coupling between power transmitter and receiver elements, such as resonators (e.g., a transmitting coil and receiving coil or other power transmitter/receiver combination), additional components may be provided in example charging hangers and/or smart textile products to assist in aligning the transmitting resonator on the surface of or embedded within a charging hanger device with the receiving resonator in or on the fabric of a smart textile product (e.g., a smart garment). As one example, permanent magnets may be placed in the core or outside of one or both of the transmitting or receiving resonators, with a corresponding ferromagnetic material placed within or near the other device. For instance, in the example of FIG. 5A, two magnets 505, 510 may be positioned, respectively at or near the center of a power transmitter element 105 (e.g., in the core of the power transmitter element 105) of charging hanger device 100 and the center (e.g., the core) of power receiver elements (e.g., 205) included in or on fabric 200 of an example textile product. In other implementations, rather than two magnets 505, 510, an implementation may include one magnet (e.g., on either the power transmitter or receiver) and another ferromagnetic material (e.g., on either the power receiver or transmitter). Additionally, in some implementations, magnets may be positioned in other locations (e.g., in addition or as an alternative to a magnet (e.g., 505, 510) positioned in the center of resonator. For instance, as shown in the example of FIG. 5B, one or more magnets (e.g., 515, 520, 525, 530) may be positioned in defined locations around the exterior edge of the resonators, among other example placements. In either implementations, a magnet-based aligner may allow for the fabric to attach to the hanger such that the transmitting and receiving resonators are aligned, thereby ensuring proper alignment while still allowing for the fabric to be removed with minimal effort.

Further, some implementations may alternatively or additionally utilize other components, such as clips, snaps, zipper, buttons, female/male connectors, among other components to temporarily and mechanically connect or otherwise align resonators of an example wireless power transmitter element (e.g., 105) and a wireless power receiver element (e.g., 205), among other example features. In some implementations, the alignment mechanism (e.g., whether mechanical or magnetic) may additionally include a sensor to indicate how a garment is aligned with the power transfer elements of the hanger, such that when a particular connector or alignment mechanism of the hanger is engaged, the circuitry and/or logic of the hanger can determine that a corresponding power transfer element (and/or data transmitting or receiving element) is capable of being successfully engaged. In some cases, such sensors may additionally trigger visual or audio indicators (e.g., lights or sounds) to provide feedback to the user that the garment and hanging device are properly (or improperly) aligned, among other examples. For instance, in an implementation of a charging hanger device with multiple alternative power transfer elements provided in different locations of the hanger (e.g., as in the examples of FIGS. 3-4), the sensors of the hanger device may be utilized to indicate which one (or more) of the power transmitter elements is best aligned with power receiver elements of a garment (or other textile product) hung on the hanger. For instance, when a magnet or mechanical alignment device of the hanger is engaged that corresponds to a particular one of the power transfer elements (e.g., 105a), the hanger can cause power from its power source to be directed only to this particular power transfer element that is aligned with the power receiver element of the textile article to be charged while hanging on the hanger device. For any power transfer elements (e.g., 105b) whose connector or alignment elements (e.g., magnets, clips, etc.) are sensed as not being engaged (e.g., because the receiver coil of the garment is not going to be aligned with these power transfer elements (e.g., 105b), the hanger may temporarily disable these power transmitter elements (as they will not be used during hanger of this particular textile article), among other examples.

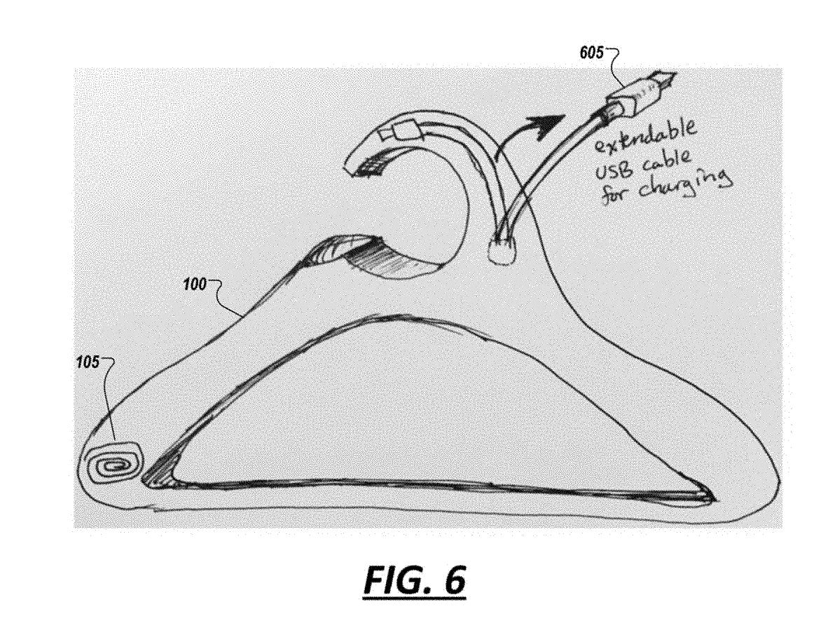

As noted above, a charging hanger may transmit power from a power source to electronics of a garment to charge a power source (e.g., a battery) powering the garment circuitry that provides various enhancements to the garment (e.g., sensors, user interfaces, visual or audio enhancements, etc.). In some implementations, the charging hanger may be provided with an internal power source, such as a battery. This may allow the charging hanger to operate in portable configurations (e.g., in luggage, in a hotel, etc.) and charge equipped smart garments outside of a home environment. In some instances, the battery (or other power supply) of the charging hanger may be rechargeable. In one implementation, the charging hanger device may be provided with additional features to facilitate recharging of the charging hanger's power source(s) directly at the charging hanger. For instance, turning to FIG. 6, a charging hanger may be provided with a power cable 605 (e.g., a USB-based cable), which may be used to connect the hanger to an external power supply and re-charge the hanger. In some instances, the power cable may be used (in lieu of an internal power supply for the hanger) to directly power the transmitting coil(s) (e.g., 105) of the hanger 100. For instance, a power cable provided on the charging hanger may be extendable (e.g., in that a portion of the cable is retracted or stored in the charging hanger and may be unwound to extend the reach of the cable). For instance, the power cable may allow the charging hanger to be connected to a power source at or near a hanging rod or hook (on which the hanger will be hung).

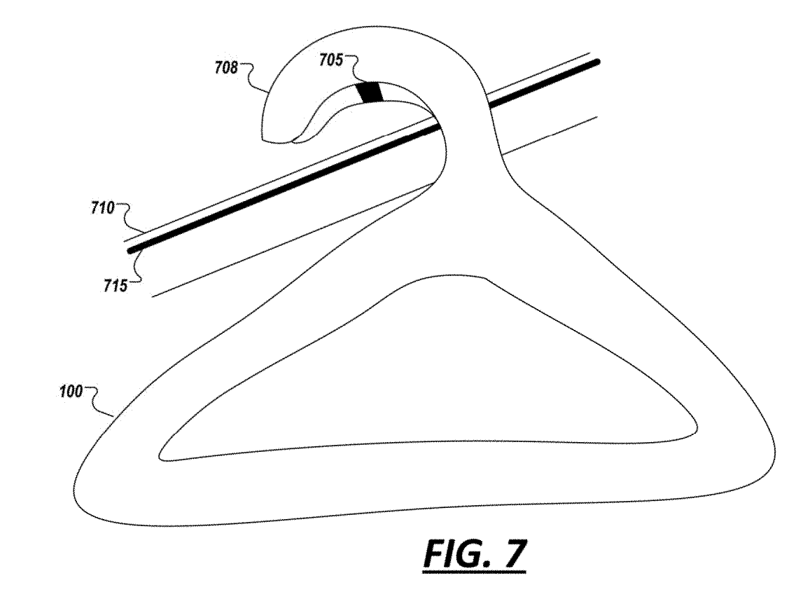

In another example implementation, illustrated in FIG. 7, a hanger 100 may be provided with its own power receiver element to allow its battery to also be wirelessly charged by an external power source. In one example, the power receiver element of an example hanger device 100 may be positioned to correspond to power transmitter elements on a hook or rod upon which the hanger device is to be hung, allowing the hanger device 100 to be charged while hanging. Such an implementation may allow power to be fed to the hanger device to power its power transmitter and thereby recharging the battery of any rechargeable garment hung on the hanger device 100 while it is hanging on a charging rod or hook element.

In one example, as shown in FIG. 7, a hanger device may be provided with a power receiver element 705 located at or near the hook 708 of the hanger to accept power from a power transmitter element (e.g., 710) located on the rod (e.g., 715) or hook on which the charging hanger 100 is to be hung. For instance, when hung on the rod 715, the receiver element 705 may be in contact with or aligned with a transmitter element 710 to allow the transmitter element 710 to provide power (e.g., wirelessly or via physical conduction) to the charging hanger 100 through the transmitter element 710 while the hanger 100 hangs on the rod 715 (or hook in other implementations). This power may then be used to recharge a battery internal to the hanger 100 or to directly power one or more transmitting coils on the charging hanger 100 and allow the charging hanger to provide power to an electronic-enhanced, or smart, garment hung on the charging hanger 100, among other example implementations.

In some cases, a wireless charging hanger may be a single device that contains all components previously mentioned, or it can serve as a modular device allowing the features containing the power source and resonator to be selectively removed from (and function independent from) the clothes hanger structure. A modular approach may allow wireless recharging components to be used without the garment being hung on the hanger (e.g., while the garment is being worn, when the garment is folded and stored (e.g., in a dresser), or when the garment is stowed in luggage, a workout bag, etc. Additionally, in one example of a modular charging hanger, recharging elements may incorporate a battery, such that the recharging elements may be removed from a hanger to allow the recharging element to be conveniently recharged (e.g., before being reattached to the hanger). In other instances, a recharging element may function (and be designed for implementation) independent from the hanger. For instance, a recharging component (e.g., equipped with magnets or clips to connect the recharging component to a garment) may allow wireless recharging of a garment's battery without the use of a hanger structure. This may be useful, for instance, in cases where a textile product is too larger otherwise shaped such that hanging the product on the hanger device is impractical or would not result in resonator alignment, among other example considerations and use cases.

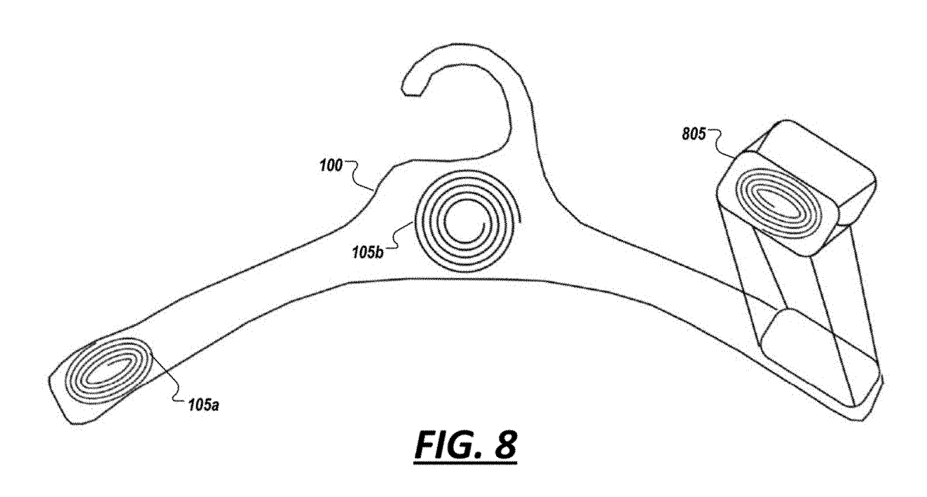

Turning to the example of FIG. 8, an example is shown of a modular charging hanger device 100, which includes one or more wireless recharging elements (e.g., 805). Such elements may be modularly removed and replaced on the charging hanger 100. In implementations where the power transmitter elements of the recharging elements 805 are individually powered (e.g., by a corresponding battery), these recharging elements 805 may effectively operate independently of other components and the structure of the charging hanger (e.g., other recharging elements (e.g., 105a,b, which may or may not be modular). In other cases, the removable recharging elements 805 may utilize or be dependent on functionality (e.g., a power source, recharging capability, etc.) of the remaining hanger device 100 (e.g., such that they can only be temporarily used independent of the hanger device), among other example implementations. In some cases, the power source of the hanger device may be implemented as a battery, such that it may be removed, allowing for it to be charged separately and reattached when hanging the garment.

As introduced in the discussion of FIG. 2B, smart textile devices may be provided that are rechargeable through example charging hanger devices. The electronic components of these smart textile devices may be implemented, in some cases, using liquid metal wires (or other conductors) which may be integrated into the fabric of the textile device itself. For instance, wires may be interwoven into the fabric or secured between layers of fabric during construction of the fabric, attached to the surface of the fabric, among other examples. Additionally, the resonators themselves may be integrated into the fabric using liquid metal technology or using solid conductors. In some implementations, liquid metal technology may implement liquid metal wires (or “fluidic wires”), which may be used to interconnect electronics integrated in a garment, implement the receiving resonator of the garment, implement an antenna within the garment, among other example applications.

A fluidic wire may be reversibly deformable and mechanically tunable and may be formed by injecting a liquid metal, such as gallium or a gallium-based alloy, into one or more sheaths or other cavities within a material substrate or a base material (e.g., coupled to a bonding layer material). Any liquid metal that has a melting point below an ambient liquid metal wire manufacturing facility temperature or the temperature of the desired operating environment may be used such that heating of the liquid metal is not required for the liquid metal to be introduced during manufacturing or for the liquid metal to retain its deformable properties in application. An example temperature range from negative twenty degrees Celsius (−20° C.) to forty degrees Celsius (40° C.) may be used in association with certain of the metals described herein that are in a liquid state within this range, though it is understood that other temperature ranges may be appropriate for other implementations of liquid metal to be used to form a reversibly deformable and mechanically tunable fluidic wire. In one example, eutectic gallium indium (EGaln) has a melting point of fifteen and seven tenths degrees Celsius (15.7° C.) and given the supercooling property of gallium may maintain this liquid property at temperatures even lower than its melting point, allowing EGaln (and other gallium-based alloys) to be used as the liquid metal within an example fluidic wire. As such, a lower end of the ambient liquid metal wire manufacturing facility temperature range for such an implementation may be considered, for example, sixteen degrees Celsius (16° C.). Other metals and temperature ranges may be used for formation of liquid metal wires that may have higher or lower melting points, and as such, different ambient liquid metal wire manufacturing facility temperature ranges.

In some cases, a fluidic wire may be constructed by injecting the liquid metal into a wire housing or sheath, or other cavity. As an alternative to injecting a liquid metal into one or more cavities, the liquid metal may be drawn into a cavity by applying a vacuum or other pulling force to the liquid metal via the cavity. In either implementation, injecting or drawing the liquid metal into the cavity may be terminated in response to the cavity filling to capacity. Alternatively, filling the cavity may be terminated on demand by cessation of the filling process upon filling of the cavity to an extent sufficient to allow radiation of electromagnetic energy via the fluidic wire. Inlet and outlet filling hole locations may be provided for the respective operations, and the cavity may be sealed in response to filling the cavity.

The term “fluidic wire” and “liquid metal wire” may be used interchangeably to represent a wire with a liquid metal resonant element. The term “material” and “substrate” may be used interchangeably to represent a substance within which a fluidic wire may be formed. The term “cavity” may be used to represent a hollow channel, capillary, conduit, sheath, groove, furrow or other structure within a substrate within which liquid metal may be filled to form a fluidic wire. The terms “cavity,” “channel,” and “capillary” or other terms may be used interchangeably hereafter to identify a void or other structure, within one or more portions of material that define a shape of a fluidic wire within the material, that may be filled with liquid metal to form a fluidic wire. For certain implementations, a channel may be considered a “microfluidic channel.”

The material within which the cavity and fluidic wire are formed may include a flexible and/or stretchable material, for example, an elastomer such as silicone or other polymer-based materials. Other examples of flexible materials include polymer films, composite substrates, gels, thin metal supports, and other flexible materials. The material within which the cavity and fluidic wire are formed may also include rigid materials such as wood, dry wall, polymeric parts, polymer films, gels, and other rigid materials. It is understood that the present subject matter applies to any material that may form a cavity that may define a shape of a fluidic wire without interfering with spectral properties of the fluidic wire beyond interference acceptable within a given implementation, and all such materials are within the scope of the present subject matter.

A cavity may be formed into a substrate in a variety of manners. Because the wire is formed with a liquid metal, the mechanical properties of the wire may be defined by mechanical properties of the substrate. As such, for an elastomeric substrate, the resulting elastomeric fluidic wire may be deformed (e.g., stretched, bent, flexed, rolled, etc.) and released/reversed without loss of electrical continuity. As a consequence, the resulting wires may be more durable relative to conventional technologies and may be utilized in applications that would otherwise result in destruction of conventional wires. Strain may be induced in a material, for example, in response to temperature changes, pressure changes, mechanical load changes, geographical changes, or any other change that results in a force on the material that deforms, elongates, shrinks, or otherwise changes the material's dimensions. For example, the fluid metal may flow in response to strain (e.g., elongation) of the elastomeric substrate, resulting in a reconfiguration of the geometry of the fluidic wire and a resulting shift in the resonant frequency of the wire, while returning to its original geometry and frequency response upon removal of the applied strain. Based upon these properties, the fluidic wire is considered to have no or minimal hysteresis, as defined by the mechanical properties of the substrate in response to mechanical strain and release of mechanical strain.

Reference throughout this specification to “one implementation” or “an implementation” means that a particular feature, structure, or characteristic described in connection with the implementation is included in at least one implementation of the present Specification. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

The following examples pertain to embodiments in accordance with this Specification. In some implementations, an apparatus is provided, which includes a hanger including one or more power transmitter elements to transfer power from a first power source to a second power source implemented on a textile article capable of being hung on the hanger, where the power transmitter element is to transmit the power to a power receiver element implemented on the textile article.

In some aspects, a power transmitter element may transmit the power to the power receiver element over a contactless interface. The power transmitter element may wirelessly transmit the power to the power receiver element, for instance, the power transmitter element may inductively charge the second power source using the power receiver element. In such instances, the power transmitter element may include a first resonator and the power receiver element may include a second resonator, or the power transmitter element may include a power transmitter coil and the power receiver element may include a power receiver coil.

In some aspects, the textile articles which may be hung on the hanger may include a garment. The hanger may include a plurality of power transmitter elements to correspond to a plurality of different areas of any one of a variety of different garments in which a corresponding power receiver may be found in the garment. The hanger may include an appendage to position a particular one of the plurality of power transmitter elements away from portions of the hanger used to physically support the textile article when hung on the hanger.

In some aspects, the hanger may include one or more permanent magnets to attract another magnet or a metallic element in the textile article corresponding to the power receiver element. The power transmitter element may include a removable power transmitter element capable of being removed from and replaced on the hanger. In some instances, a hanger device may itself include a power source or power receiver to access the power to provide to the power receiver element. For instance, the power source may include a battery internal to the hanger. In some instances, the power source may be a source external to the hanger, and the power receiver may connect the hanger to the power source external to the hanger. For instance, the power receiver includes a cable. In cases where a battery is provided within the hanger, the battery is to be recharged by the power source external to the hanger.

In some aspects, the hanger further comprises a processor, memory, and a data transmitter to wirelessly send data to a data receiver element included in the textile article. The hanger may also, or instead, include a data receiver to wirelessly receive data from a data transmitter element included in the textile article. The hanger may be shaped as a clothes hanger with a portion to hang from a hanger rod or hook and another portion over which clothing may be draped, clipped, or otherwise hung on the hanger.

In some implementations, a textile article may be provided, which include a first power source; and a power receiver element, such as a receiver resonator, positioned on the textile article to correspond with a defined location on a hanger device, wherein the defined location corresponds to a power transmitter element on the hanger device, such as a transmitter resonator, configured to transfer power from a second power source to the first power source.

In some aspects, the power transmitter element includes a power transmitter coil and the receiver resonator comprises a power receiver coil. The power receiver coil may include a coil constructed from a fluidic wire. The power source may include a battery. The textile article may include circuitry to recharge the battery using the power received at the receiver resonator. The textile article may include one or more elements to physically align the receiver resonator to the transmitter resonator. The elements may include one or more magnets, which may couple with magnets on the hanger device to cause the power receiver element to align with one of the power transmitter elements on the hanger device.

In some instances, the textile article may include a garment. For instance, the garment may be embodied by such examples as an elastomeric athletic garment, a garment top (e.g., a shirt, blouse, bra, swimsuit top, coat, jacket, sweater, etc.), a head covering (e.g., a scarf, helmet, hat, cap, beanie, headband, etc.), a garment bottom (e.g., pants, skirt, shorts, underwear, swim bottoms, etc.), among other examples (e.g., industrial, athletic, or military uniforms, dresses, tunics, overalls, bodysuits, etc.). In some instances, the textile article may include upholstery, such upholstery that may be included or positioned on pieces of furniture, vehicle seating, as wall or ceiling décor, among other examples.

Thus, particular embodiments of the subject matter have been described.

Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

A detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. An apparatus comprising:
a hanger comprising:
one or more power transmitter elements to transfer power from a first power source to a second power source implemented on a textile article capable of being hung on the hanger, where the power transmitter element is to wirelessly transmit the power to a power receiver element implemented on the textile article.

2. The apparatus of claim 1, wherein the power transmitter element is to transmit the power to the power receiver element over a contactless interface.

3. The apparatus of claim 2, wherein the power transmitter element is to inductively charge the second power source using the power receiver element.

4. The apparatus of claim 3, wherein the power transmitter element comprises a first resonator and the power receiver element comprises a second resonator.

5. The apparatus of claim 4, wherein the power transmitter element comprises a power transmitter coil and the power receiver element comprises a power receiver coil.

6. The apparatus of claim 1, wherein the textile article comprises a garment, and the hanger comprises a plurality of power transmitter elements each correspond to a respective one of a plurality of different defined areas within which a power receiver element may be positioned within a respective garment.

7. The apparatus of claim 6, wherein the hanger comprises an appendage to position a particular one of the plurality of power transmitter elements away from portions of the hanger used to physically support the textile article when hung on the hanger.

8. The apparatus of claim 6, wherein the hanger further comprises:
one or more sensors to detect that the power receiver element is aligned with one or more of the plurality of power transmitter elements; and
circuitry to selectively enable the one or more power transmitter elements based on detecting that the one or more power transmitter elements are aligned with the power receiver element.

9. The apparatus of claim 1, wherein the hanger comprises one or more permanent magnets to attract a ferromagnetic element in the textile article corresponding to the power receiver element to align the power transmitter element with the power receiver element.

10. The apparatus of claim 1, wherein the power transmitter element comprises a removable power transmitter element capable of being removed from and replaced on the hanger.

11. The apparatus of claim 1, wherein the hanger further comprises an energy storage device and a particular power receiver to receive power to provide to the energy storage device.

12. The apparatus of claim 11, wherein the power receiver comprises a cable to connect to a power source external to the hanger.

13. The apparatus of claim 11, wherein the power receiver comprises a particular power receiver element.

14. The apparatus of claim 13, wherein the particular power receiver element is positioned to correspond with a hook of the hanger.

15. The apparatus of claim 1, wherein the hanger further comprises a processor, memory, and a communication module to wirelessly send data to a data receiver element included in the textile article.

16. The apparatus of claim 1, wherein the hanger further comprises a processor, memory, and a communication module to wirelessly receive data from a data transmitter element included in the textile article, and the processor is to store the data in the memory.

17. The apparatus of claim 1, wherein the hanger comprises a clothes hanger.

18. A method comprising:
hanging a textile article on a hanger device, wherein:
the hanger device comprises a power transmitter element,
the textile article comprises power receiver element, an energy storage module to be recharged using the power receiver element, and electronic circuitry to be powered by the battery, and
hanging the textile article on the hanger device causes the power transmitter element to be physically aligned with the power receiver element; and
transferring energy from the hanger device to the battery, wherein the energy is transferred inductively from the power transmitter element to the power receiver element.

19. A textile article comprising:
a first power source; and
a receiver resonator positioned on the textile article to correspond with a defined location on a hanger device, wherein the defined location corresponds to a transmitter resonator on the hanger device configured to transfer power from a second power source to the first power source while the textile article is hung on the hanger device.

20. The article of claim 19, wherein the receiver resonator comprises a power receiver coil and the power receiver coil comprises a coil constructed from a fluidic wire.
